(19) United States
(12) Patent Application Publication
(10) Pub. No.: US 2022/0364941 A1
(43) Pub. Date: Nov. 17, 2022

(54) SENSOR DEVICE

(71) Applicant: SONY GROUP CORPORATION, TOKYO (JP)

(72) Inventor: KAZUO HONGO, TOKYO (JP)

(21) Appl. No.: 17/771,272

(22) PCT Filed: Oct. 16, 2020
(86) PCT No.: PCT/JP2020/039122

§ 371 Date: Apr. 22, 2022

(30) Foreign Application Priority Data
Oct. 31, 2019 (JP) 2019-198483

(51) Int. Cl. G01L 5/166; G02B 17/00; G01L 1/24

(52) U.S. Cl. CPC G01L 5/166; G02B 17/004; G01L 1/248

(57) ABSTRACT

A sensor device includes: a light-emitting section that outputs light to a first mirror or a second mirror, the second mirror facing the first mirror and being configured to change an orientation with respect to the first mirror; and a light-receiving section that receives reflection light, reflected from the first mirror and the second mirror, of the light outputted from the light-emitting section.

### TECHNICAL FIELD

The present disclosure relates to a sensor device.

### BACKGROUND ART

Recently, a sensor has been proposed that detects a magnitude of an external force applied to an object in various methods (for example, see Patent Literature 1). For example, a sensor has been proposed that detects a magnitude of an external force applied to an object by optically or electromagnetically detecting a deformation of the object.

### CITATION LIST

### Patent Literature

Patent Literature 1: Japanese Unexamined Patent Application Publication No. H10-274573

### SUMMARY OF THE INVENTION

It is desirable that a sensor device used to detect an external force applied to an object or to detect a deformation of the object by the external force be high in sensitivity and high in rigidity.

Accordingly, it is desirable to provide a sensor device that is high in sensitivity and high in rigidity.

A sensor device according to one embodiment of the present disclosure includes: a light-emitting section that outputs light to a first mirror or a second mirror, the second mirror facing the first mirror and being configured to change an orientation with respect to the first mirror; and a light-receiving section that receives reflection light, reflected from the first mirror and the second mirror, of the light outputted from the light-emitting section.

According to the sensor device of one embodiment of the present disclosure, between the first mirror and the second mirror that faces the first mirror and is configured to change the orientation with respect to the first mirror, the light is outputted from the light-emitting section, and the reflection light, reflected from the first mirror and the second mirror, of the light outputted from the light-emitting section is received by the light-receiving section. Thus, it is possible to make long a light path length from the light-emitting section to the light-receiving section by, for example, a multiple reflection between the first mirror and the second mirror. Hence, it is possible to increase a displacement of a light-receiving position in the light-receiving section resulting from a displacement of the second mirror, without increasing a distance between the first mirror and the second mirror.

### BRIEF DESCRIPTION OF THE DRAWINGS

FIG. 1 is an explanatory diagram schematically illustrating a basic configuration of a sensor device according to a first embodiment of the present disclosure.

FIG. 2 is a schematic diagram illustrating a detection principle of an optical strain sensor.

FIG. 3A is a schematic diagram illustrating an entrance path of light from a light-emitting section to a light-receiving section in a case of no reflection.

FIG. 3B is a schematic diagram illustrating an entrance path of the light from the light-emitting section to the light-receiving section in a case of one-time reflection.

FIG. 3C is a schematic diagram illustrating an entrance path of the light from the light-emitting section to the light-receiving section in a case of two times reflection.

FIG. 3D is a schematic diagram illustrating an entrance path of the light from the light-emitting section to the light-receiving section in a case of three times reflection.

FIG. 4A is a schematic diagram illustrating a reflection position of reflection light at a first mirror and a second mirror that face each other.

FIG. 4B is a schematic diagram illustrating a reflection position of reflection light at the first mirror and the second mirror that face each other.

FIG. 5A is a schematic diagram illustrating a modification example of the first mirror or the second mirror.

FIG. 5B is a schematic diagram illustrating a modification example of the first mirror or the second mirror.

FIG. 5C is a schematic diagram illustrating a modification example of the first mirror or the second mirror.

FIG. 6A is a schematic diagram illustrating one mode of a first concrete example of the sensor device according to the embodiment.

FIG. 6B is a schematic diagram illustrating one mode of the first concrete example of the sensor device according to the embodiment.

FIG. 7 is a perspective diagram illustrating a detailed configuration of the first concrete example of the sensor device according to the embodiment.

FIG. 8 is a perspective diagram illustrating a detailed configuration of the first concrete example of the sensor device according to the embodiment.

FIG. 9 is a perspective diagram illustrating a detailed configuration of the first concrete example of the sensor device according to the embodiment.

FIG. 10A is a schematic diagram illustrating one mode of a second concrete example of the sensor device according to the embodiment.

FIG. 10B is a schematic diagram illustrating one mode of the second concrete example of the sensor device according to the embodiment.

FIG. 11 is a perspective diagram illustrating a detailed configuration of a third concrete example of the sensor device according to the embodiment.

FIG. 12A is a perspective diagram illustrating a configuration on an attachment face side of a first member.

FIG. 12B is a perspective diagram illustrating a configuration on an attachment face side of a second member.

FIG. 13A is a cross-sectional diagram illustrating more specifically a configuration of a sensor device configured by the first mirror, the second mirror, the light-emitting section, and the light-receiving section.

FIG. 13B is a cross-sectional diagram illustrating more specifically a configuration of the sensor device configured by the first mirror, the second mirror, the light-emitting section, and the light-receiving section.

FIG. 14A is a perspective diagram schematically illustrating a basic configuration of a sensor device according to a second embodiment of the present disclosure.

FIG. 14B is a front diagram in which the sensor device illustrated in FIG. 14A is viewed in a plan view in a direction from the light-receiving section to the light-emitting section.

FIG. 14C is a side diagram in which the sensor device illustrated in FIG. 14A is viewed in a plan view from a third mirror.

FIG. 15 is a schematic diagram illustrating a basic structure of a sensor device that uses three reflection mirrors.

FIG. 16A is a schematic diagram illustrating a variation of a region in which a deformation occurs in the sensor device illustrated in FIG. 15.

FIG. 16B is a schematic diagram illustrating a variation of the region in which the deformation occurs in the sensor device illustrated in FIG. 15.

FIG. 16C is a schematic diagram illustrating a variation of the region in which the deformation occurs in the sensor device illustrated in FIG. 15.

FIG. 17 is a schematic diagram illustrating a basic structure of a sensor device that uses four reflection mirrors.

FIG. 18A is a schematic diagram illustrating a variation of a region in which a deformation occurs in the sensor device illustrated in FIG. 17.

FIG. 18B is a schematic diagram illustrating a variation of the region in which the deformation occurs in the sensor device illustrated in FIG. 17.

FIG. 18C is a schematic diagram illustrating a variation of the region in which the deformation occurs in the sensor device illustrated in FIG. 17.

FIG. 18D is a schematic diagram illustrating a variation of the region in which the deformation occurs in the sensor device illustrated in FIG. 17.

### MODES FOR CARRYING OUT THE INVENTION

Hereinafter, embodiments of the present disclosure will be described in detail with reference to the drawings. The embodiments to be described below are concrete examples of the present disclosure, and a technique according to the present disclosure is not limited to the following embodiments. In addition, the arrangement, the dimensions, the dimensional ratios, and the like of the respective components of the present disclosure are not limited to the embodiments illustrated in the respective drawings.

It should be noted that the description will be given in the following order.
1. First Embodiment

1.1. Basic Configuration

1.2. Workings and Effects

1.3. Modification Examples

1.4. Concrete Examples
2. Second Embodiment
3. Conclusion

### 1. FIRST EMBODIMENT

### 1.1. BASIC CONFIGURATION

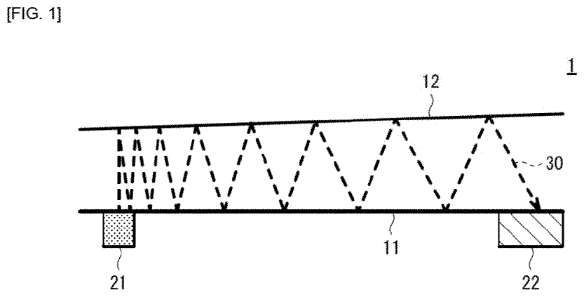

First, a basic configuration of a sensor device 1 according to a first embodiment of the present disclosure will be described with reference to FIG. 1. FIG. 1 is an explanatory diagram schematically illustrating a basic configuration of the sensor device 1 according to the first embodiment of the present disclosure.

Referring to FIG. 1, the sensor device 1 according to the present embodiment includes a light-emitting section 21 and a light-receiving section 22. The light-emitting section 21 and the light-receiving section 22 are provided on respective end part sides of a first mirror 11 and a second mirror 12 that face each other. For example, the light-emitting section 21 may be provided at an end part of one of the first mirror 11 and the second mirror 12, and the light-receiving section 22 may be provided at the other end part that is on an opposite side of the end part of one of the first mirror 11 and the second mirror 12. The sensor device 1 may be provided as a sensor that includes the light-emitting section 21 and the light-receiving section 22 as described above and does not include the first mirror 11 and the second mirror 12, or as a sensor that includes the light-emitting section 21, the light-receiving section 22, the first mirror 11, and the second mirror 12.

Light 30 outputted from the light-emitting section 21 is reflected multiple times back and forth between the first mirror 11 and the second mirror 12 that face each other, following which the light 30 is received by the light-receiving section 22. It is possible for the sensor device 1 according to the present embodiment to detect an external force applied to the sensor device 1 by detecting a displacement of a light-receiving position of the light in the light-receiving section 22.

The first mirror 11 and the second mirror 12 are a pair of reflection mirrors so provided as to face each other. Specifically, the first mirror 11 and the second mirror 12 may be so provided as to have a longitudinal shape that extends in the same one direction as each other. For example, the first mirror 11 and the second mirror 12 may be so provided as to have a longitudinal shape that extends on a side in a direction in which the light 30 from the light-emitting section 21 is outputted. With this configuration, it is possible for the first mirror 11 and the second mirror 12 to cause the light 30 to be subjected to a multiple reflection continuously in a mutually-opposing space. The first mirror 11 and the second mirror 12 may be provided as a configuration of the sensor device 1 or may be provided as a separate configuration from the sensor device 1.

The first mirror 11 functions as a reference member for detecting the external force applied to the sensor device 1, and is fixed in position and orientation. On the other hand, the second mirror 12 functions as a detection member that detects the external force applied to the sensor device 1, and is configured to change an orientation with respect to the first mirror. Specifically, a strain-causing member or the like that deforms in accordance with a magnitude of the external force applied to the sensor device 1 is coupled to the second mirror 12, and the second mirror 12 is configured to change the orientation with respect to the first mirror 11 in accordance with a deformation of the strain-causing member. With this configuration, it is possible for the second mirror to change a light path and a reflection position of the light 30 having been subjected to the multiple reflection between the first mirror 11 and the second mirror 12 by changing the orientation with respect to the first mirror 11 in accordance with the external force applied to the sensor device 1. Accordingly, it is possible for the sensor device 1 according to the present embodiment to detect the magnitude of the external force applied to the sensor device 1 as the displacement of the light-receiving position of the light-receiving section 22 via the strain-causing member and the second mirror 12.

The light-emitting section 21 includes a light source that emits light belonging to any wavelength band and outputs the light 30 toward one of the first mirror 11 and the second mirror 12. For example, the light-emitting section 21 may include LED (Light Emitting Diode) light source that emits light of a color that belongs to a visible-light band, an infrared LED light source, or a laser light source. The LED light source or the infrared LED light source is easy to handle and inexpensive, making it possible to reduce manufacturing costs of the sensor device 1. The laser light source is difficult to handle because it is difficult to adjust the light path by the first mirror 11 and the second mirror 12 and easily generates a heat, but it is easy to detect a light spot, making it possible to further improve a sensitivity and an accuracy of the sensor device 1.

The light-receiving section 22 includes a sensor that makes it possible to detect the light 30 outputted from the light-emitting section 21, and receives the light 30 having been subjected to the multiple reflection by the first mirror 11 and the second mirror 12. For example, the light-receiving section 22 may include an RGB (Red, Green, Blue) camera, an infrared camera, an event camera, or a light position sensor (Position Sensitive Detector: PSD). The RGB camera or the infrared camera is a so-called imaging device, and it is possible to easily detect a light-receiving position of the light 30. The event camera is a sensor that detects a change in luminance and outputs the detected change in the luminance The event camera outputs only data of a pixel in which a luminance has changed, making it possible to detect the light 30 outputted from the light-emitting section 21 at an extremely high frame rate.

The light-emitting section 21 and the light-receiving section 22 may be provided on the same side with respect to the first mirror 11 and the second mirror 12. In such a case, in the sensor device 1, it is possible to dispose a power wiring line, a signal wiring line, etc., to the light-emitting section 21 and the light-receiving section 22 collectively on the same side, and thereby to further simply a structure of the sensor device 1. For example, the light-emitting section 21 and the light-receiving section 22 may be provided on a side on which the first mirror 11 is present. Because the light-emitting section 21 and the light-receiving section 22 are configurations related to sensing of the sensor device 1, it is possible to improve an accuracy of the sensing in the sensor device 1 by providing the light-emitting section 21 and the light-receiving section 22 on the first mirror 11 side whose position is fixed. In addition, in a case where the light-emitting section 21 and the light-receiving section 22 are provided on the first mirror 11 side, it is possible to avoid a risk of a stress that acts on the second mirror 12, which is detection member, resulting from the wiring lines for the light-emitting section 21 and the light-receiving section 22.

Although not illustrated, the sensor device 1 according to the present embodiment may include a force detecting section that detects the magnitude of the external force applied to the sensor device 1 on the basis of the displacement of the light-receiving position of the light in the light-receiving section 22. For example, the force detecting section may derive a deformation amount of the strain-causing member coupled to the second mirror 12 using a reflection model, to the light-receiving section 22, of the light 30 outputted from the light-emitting section 21, and may derive the magnitude of the external force applied to the sensor device 1 from the deformation amount of the strain-causing member. Alternatively, the force detecting section may derive the magnitude of the external force applied to the sensor device 1 by performing a calibration on the basis of a displacement amount of the light-receiving position of the light 30 in the light-receiving section 22 at the time when a predetermined external force is applied to the sensor device 1. It should be noted that the force detecting section may be provided outside the sensor device 1.

It should be noted that the sensor device 1 according to the present embodiment may be provided as, for example, MEMS (Micro Electro Mechanical Systems) or a semiconductor device. With this configuration, it is possible for the sensor device 1 according to the present embodiment to achieve a miniaturization more easily.

### 1.2. WORKINGS AND EFFECTS

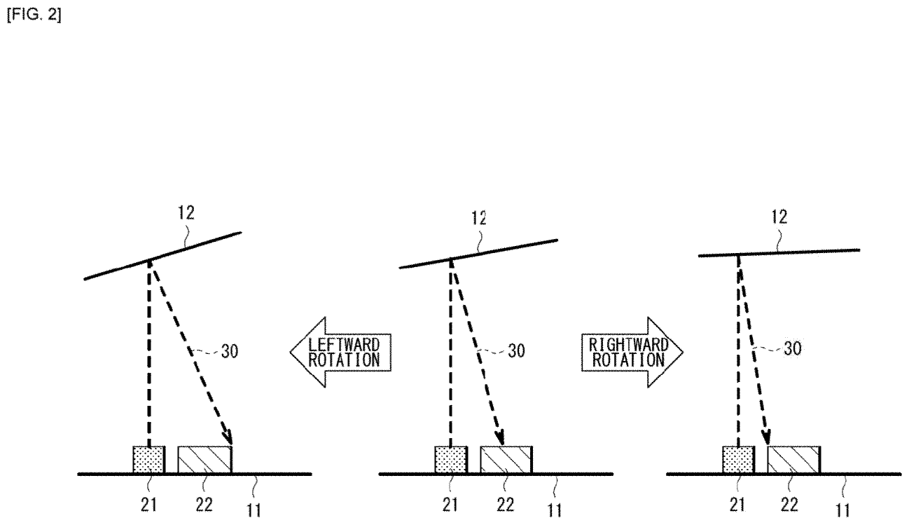

Next, referring to FIG. 2 to FIG. 4B, workings and effects of the sensor device 1 according to the present embodiment will be described. First, referring to FIG. 2, a detection principle of an optical strain sensor will be described. FIG. 2 is a schematic diagram illustrating a detection principle of the optical strain sensor.

It is possible for the optical strain sensor to detect a strain or a deformation of a strain-causing member by applying light to the strain-causing member that causes the strain or the deformation by an external force and detecting a position of the light reflected by the strain-causing member. It is also possible for the optical strain sensor to determine the external force applied to the strain-causing member from a magnitude of the strain or the deformation of the strain-causing member.

For example, as illustrated in FIG. 2, the second mirror 12 is provided to pivot relative to the first mirror 11 by the strain or the deformation of the strain-causing member to which the external force is applied. In such a case, in a case where the second mirror 12 is rotated leftward by the strain or the deformation of the strain-causing member, the light 30 reflected by the second mirror 12 is received by the light-receiving section 22 at a position more away from the light-emitting section 21. On the other hand, in a case where the second mirror 12 is rotated rightward by the strain or the deformation of the strain-causing member, the light 30 reflected by the second mirror 12 is received by the light-receiving section 22 at a position closer to the light-emitting section 21.

Here, in order to detect the pivot of the second mirror 12 with high sensitivity, it is important to increase a displacement of the position at which the light 30 reflected by the second mirror 12 is received by the light-receiving section 22.

For example, in a case where the second mirror 12 is rotated at an angle θ with respect to the first mirror 11, an angle at which the light 30 incident on the second mirror 12 is to be reflected by the second mirror is changed by 2θ. Accordingly, when the light 30 reflected by the second mirror 12 reaches the light-receiving section 22, the light-receiving position of the light 30 in the light-receiving section 22 is displaced by a distance in which a distance between the first mirror 11 and the second mirror 12 is multiplied by sin 2θ. That is, it is possible to increase the displacement of the light-receiving position of the light 30 in the light-receiving section 22 as the distance between the first mirror 11 and the second mirror 12 (i.e., a light path length from the light-emitting section 21 to the light-receiving section 22) is increased.

However, increasing the distance between the first mirror 11 and the second mirror 12 leads to an increase in a size of the sensor device 1, which increases a load of a device on which the sensor device 1 is to be mounted.

Accordingly, the sensor device 1 according to the present embodiment extends the light path length from the light-emitting section 21 to the light-receiving section 22 by causing the light 30 to be subjected to the multiple reflection between the first mirror 11 and the second mirror 12. With this configuration, it is possible for the sensor device 1 according to the present embodiment to detect the deformation of the strain-causing member with high sensitivity even with a smaller structure.

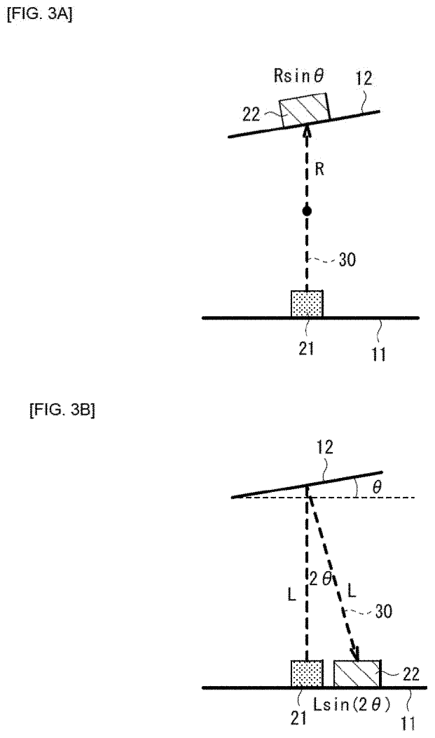

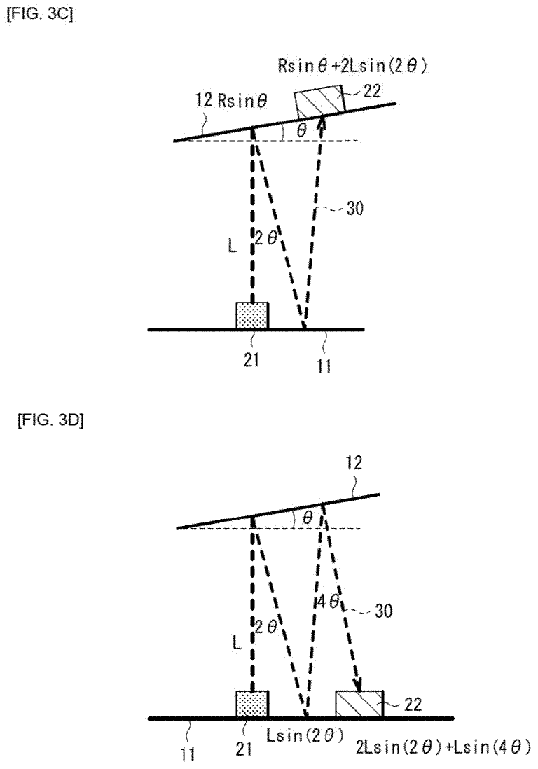

Hereinafter, an amplification of the displacement by the multiple reflection between the first mirror 11 and the second mirror 12 will be described with reference to FIGS. 3A to 3D. FIG. 3A is a schematic diagram illustrating an entrance path of the light 30 from the light-emitting section 21 to the light-receiving section 22 in a case of no reflection. FIG. 3B is a schematic diagram illustrating an entrance path of the light 30 from the light-emitting section 21 to the light-receiving section 22 in a case of one-time reflection. FIG. 3C is a schematic diagram illustrating an entrance path of the light 30 from the light-emitting section 21 to the light-receiving section 22 in a case of two times reflection. FIG. 3D is a schematic diagram illustrating an entrance path of the light 30 from the light-emitting section 21 to the light-receiving section 22 in a case of three times reflection.

In FIG. 3A, it is assumed that the second mirror 12 is pivoted with respect to the first mirror 11 at the angle θ about a midpoint between the light-emitting section 21 provided on the first mirror 11 and the light-receiving section 22 provided on the second mirror 12. Further, in FIG. 3B to FIG. 3D, it is assumed that the second mirror 12 is pivoted with respect to the first mirror 11 at the angle θ, with reference to the case where the light 30 outputted from the light-emitting section 21 is incident perpendicularly on the second mirror 12.

As illustrated in FIG. 3A, the second mirror 12 is rotated by the angle θ in the case of no reflection. Accordingly, in the light-receiving section 22 present at a position of a radius R from the pivot center of the second mirror 12, the light-receiving position is displaced by R sin θ in response to the pivot of the second mirror 12.

On the other hand, as illustrated in FIG. 3B, the light 30 from the light-emitting section 21 is reflected at the angle 2θ by the second mirror 12 in the case of one-time reflection. Accordingly, in the light-receiving section 22 provided on the first mirror 11 side, the light-receiving position of the light 30 is displaced by L sin(2θ) (where L≈2R) as compared with a case where the light 30 outputted from the light-emitting section 21 is reflected perpendicularly by the second mirror 12. In a case where θ is sufficiently small, it is possible to consider sin θ to be substantially equal to θ; accordingly, the displacement amount of the light-receiving position in the light-receiving section 22 in the case of one-time reflection is about 4 times the displacement amount (R sin θ) of the case of no reflection.

In addition, as illustrated in FIG. 3C, in the case of two times reflection, the light 30 outputted from the light-emitting section 21 is sequentially reflected by the second mirror 12 and the first mirror 11 and enters the light-receiving section 22 as with the cases illustrated in FIGS. 3A and 3B. Because the light-receiving position of the light 30 in the light-receiving section 22 at this time is considered to be the addition of the case illustrated in FIG. 3A and the case illustrated in FIG. 3B, the light-receiving position of the light 30 is displaced by R sin θ+2 L sin(2θ). Accordingly, the displacement amount of the light-receiving position in the light-receiving section 22 in the case of two times reflection is about 9 times the displacement amount (R sin θ) of the case of no reflection.

Further, as illustrated in FIG. 3D, in the case of three times reflection, the light outputted from the light-emitting section 21 is sequentially reflected by the second mirror 12, the first mirror 11, and the second mirror 12 and enters the light-receiving section 22 as with the cases illustrated in FIGS. 3A to 3C. Because the light-receiving position of the light 30 in the light-receiving section 22 at this time is considered to be the addition of two times of the case illustrated in FIG. 3B, the light-receiving position of the light 30 is displaced 2 L sin(2θ)+L sin(4θ) in consideration of an increase in an incidence angle due to the increase in the number of reflections. Accordingly, the displacement amount of the light-receiving position in the light-receiving section 22 in the case of three times reflection is about 16 times the displacement amount (R sin θ) of the case of no reflection.

In this way, the light-receiving position in the light-receiving section 22 of the light outputted from the light-emitting section 21 is amplified by a magnification of (N+1)², depending on the number of reflections N between the first mirror 11 and the second mirror 12. Hence, it is possible for the sensor device 1 according to the present embodiment to make long the light path length from the light-emitting section 21 to the light-receiving section 22 without increasing the size of the device by using the multiple reflection between the first mirror 11 and the second mirror 12.

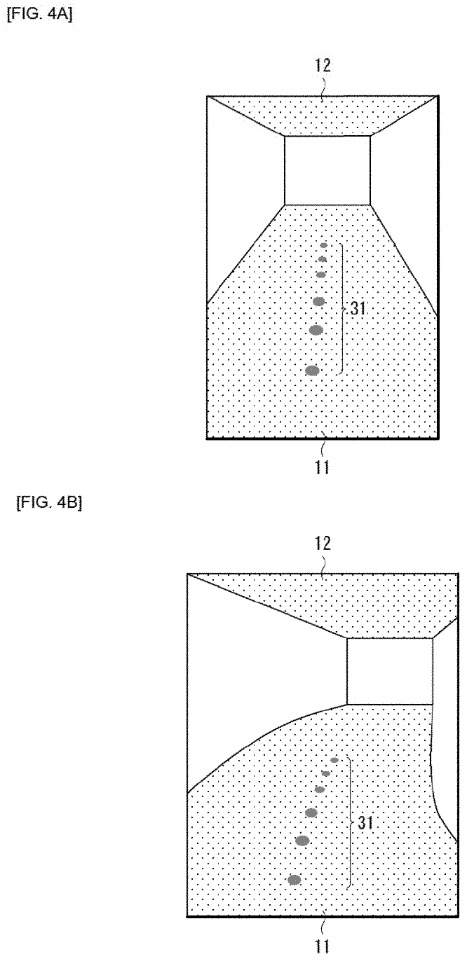

Described now, with reference to FIGS. 4A and 4B, is an image of the increase in the displacement amount of the reflection position by the multiple reflection. FIGS. 4A and 4B are each a schematic diagram illustrating the reflection position of the reflection light 31 at the first mirror 11 and the second mirror 12 that face each other. FIG. 4A illustrates an image of the reflection light 31 in a case where the second mirror 12 is directly opposite (i.e., not tilted) to the first mirror 11, and FIG. 4B illustrates an image of the reflection light 31 in a case where the second mirror 12 is tilted rightward in such a manner as to be directly opposite to the drawing.

In FIGS. 4A and 4B, the light-emitting section 21 is provided on the near side in such a manner as to be directly opposite to the drawing, and the light-receiving section 22 is provided on the back side in such a manner as to be directly opposite to the drawing. Accordingly, in FIGS. 4A and 4B, the reflection light 31 of the reflection position on the back side directly opposite to the drawing is larger in the number of reflections than the reflection light 31 of the reflection position on the near side.

As illustrated in FIG. 4A, in a case where the second mirror 12 is directly opposite (i.e., not tilted) to the first mirror 11, the reflection position of the reflection light 31 on the first mirror 11 is present on a substantially straight line. On the other hand, as illustrated in FIG. 4B, the reflection position of the reflection light 31 on the first mirror 11 is displaced on a curved line that is curved rightward in a case where a load is so applied that the second mirror 12 is tilted rightward. That is, it can be seen in FIG. 4B that the reflection light 31 of the reflection position on the back side directly opposite to the drawing is displaced more than the reflection light 31 of the reflection position on the near side, with respect to the reflection position of the reflection light 31 illustrated in FIG. 4A.

Accordingly, it is possible for the sensor device 1 according to the present embodiment to increase the displacement amount of the position of the light to be detected by the light-receiving section 22 by using the multiple reflection between the first mirror 11 and the second mirror 12. With this configuration, it is possible for the sensor device 1 according to the present embodiment to improve the sensitivity and the accuracy of the sensing with respect to the strain or the deformation of the strain-causing member without increasing the size of structure. Hence, it is also possible for the sensor device 1 according to the present embodiment to detect the external force applied to the strain-causing member with higher sensitivity and higher accuracy.

It is possible for the sensor device 1 according to the present embodiment to detect the smaller strain or the smaller deformation of the strain-causing member, allowing the strain-causing member to be formed by a higher rigidity material or structure. Accordingly, the sensor device 1 allows for high rigidity and thus allows for an attachment suitably to a part close to a base of a robot arm in which supporting of a large mass is demanded, or to a ground-connected part of a leg of a robot to which a large external force is to be applied, or to an end effector part of the robot arm.

### 1.3. MODIFICATION EXAMPLES

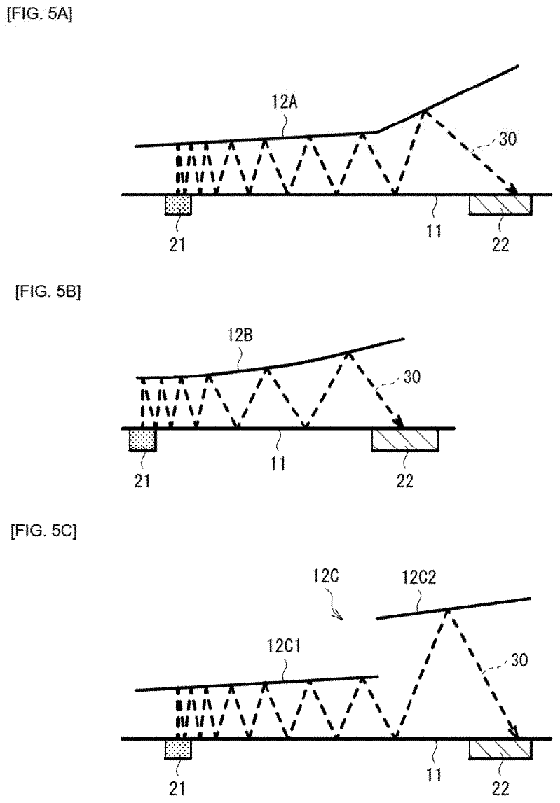

Next, modification examples of the sensor device 1 according to the present embodiment will be described with reference to FIGS. 5A to 5C, etc.

Referring to FIGS. 5A to 5C, in the sensor device 1 according to the present embodiment, it is possible for the first mirror 11 and the second mirror 12 to take various forms other than the flat plate having the longitudinal shape that extends in one direction. FIGS. 5A to 5C are each a schematic diagram illustrating a modification example of the first mirror 11 or the second mirror 12.

For example, as illustrated in FIG. 5A, a second mirror 12A may be so provided as to have a shape in which a portion of the flat plate shape is bent. Specifically, the second mirror 12A may be provided to have a bent flat plate shape such that a distance between the first mirror 11 and the second mirror 12A is wider on the light-receiving section 22 side, with a straight line orthogonal to an array direction of the light-emitting section 21 and the light-receiving section 22 being a folding line.

In addition, as illustrated in FIG. 5B, a second mirror 12B may be so provided as to have a curved shape in which a reflection surface becomes a curved surface. Specifically, the second mirror 12B may be provided to have a curved flat plate shape such that a distance between the first mirror 11 and the second mirror 12A is wider on the light-receiving section 22 side.

Further, as illustrated in FIG. 5C, a second mirror 12C may be configured by a plurality of division mirrors 12C1 and 12C2 each having a flat plate shape. Specifically, the second mirror 12C may be configured by the division mirrors 12C1 and 12C2 that have the flat plate shapes and pivot in conjunction with each other with respect to the first mirror 11. In addition, the division mirror 12C2 provided more on the light-receiving section 22 side than the division mirror 12C1 may be provided farther from the first mirror 11 than the division mirror 12C1 such that a distance between the first mirror 11 and the second mirror 12A is wider on the light-receiving section 22 side.

According to the modification examples illustrated in FIGS. 5A to 5C, it is possible for the sensor device 1 to increase the light path length of the light 30 outputted from the light-emitting section 21 by partially increasing the distance between the first mirror 11 and the second mirror 12. Thus, it is possible for the sensor device 1 to make greater the displacement amount of the light-receiving position in the light-receiving section 22. In particular, by increasing the distance between the first mirror 11 and the second mirror 12 on the side distant from the light-emitting section 21, it is possible to make greater the displacement amount of the light-receiving position in the light-receiving section 22.

The modification examples illustrated in FIGS. 5A to 5C are modification examples of partially increasing the distance between the first mirror 11 and the second mirror 12, for example, by effectively utilizing a space in a case where the space in which the first mirror 11 and the second mirror 12 are provided is limited. With this configuration, it is possible for the sensor device 1 to further improve the sensitivity and the accuracy of the sensing by making greater the displacement amount of the light-receiving position in the light-receiving section 22.

Further, in the sensor device 1 according to the present embodiment, it is also possible for the light-emitting section 21 to include a plurality of light sources. By including the plurality of light sources, it is possible to for the light-emitting section 21 to improve the sensitivity and the accuracy of the sensor device 1 and to improve a resistance to a failure of a light source.

The light-emitting section 21 may include a plurality of light sources that outputs pieces of light belonging to different wavelength bands. With this configuration, it is possible for the sensor device 1 to detect a state of the second mirror 12 with higher accuracy by detecting the light 30 belonging to the different wavelength bands by the light-receiving section 22. In particular, it is possible for the sensor device 1 to detect a positional relationship between the first mirror 11 and the second mirror 12 with higher accuracy immediately after the activation of the device.

For example, the light source included in the light-emitting section 21 may be configured to adjust a light amount of the light 30 to be outputted. Specifically, the light-emitting section 21 may be provided with a control circuit or a variable resistor for adjusting the light amount of the light 30 to be outputted from the light source. With this configuration, it becomes possible for the sensor device 1 to optimize the light amount of the light 30 to be outputted from the light-emitting section 21 in response to a magnitude and a light amount of the light 30 to be received by the light-receiving section 22. Accordingly, for example, in a case where respective light spots of the light 30 having been subjected to the multiple reflection by the first mirror 11 and the second mirror 12 are large and it is difficult to separate them from each other, it is possible to reduce the light amount of the light 30 to be outputted from the light-emitting section 21. In addition, in a case where the light amount of the light 30 received by the light-receiving section 22 is too small, it is possible to increase the light amount of the light 30 to be outputted from the light-emitting section 21.

Further, in the sensor device 1 according to the present embodiment, it is also possible for the light-receiving section 22 to include a plurality of sensors.

For example, the light-receiving section 22 may include a plurality of RGB cameras (such as CMOS image sensors). With this configuration, it is possible for the sensor device 1 to detect reflection light in a wider range by carrying out imaging of different regions by the plurality of RGB cameras. Alternatively, it is also possible for the sensor device 1 to detect the reflection light with higher accuracy by carrying out imaging of the same region by the plurality of RGB cameras.

For example, the light-receiving section 22 may include various different types of sensors, including the RGB camera and the event camera. With this configuration, it is possible for the sensor device 1 to perform a division of roles for respective sensors, like performing the calibration immediately after the activation or periodically by the RGB camera and performing the detection of the reflection light upon the sensing by the event camera.

It should be noted that the light-receiving section 22 may include only the event camera. Because the event camera is a sensor that detects a change in luminance and outputs the detected change in the luminance, it is possible to detect stationary states of the first mirror 11 and the second mirror 12 by blinking the light source of the light-emitting section 21.

Further, the sensor device 1 may include a mechanism for maintaining an overall temperature constant. For example, in a case where a temperature of the sensor device 1 fluctuates due to a heat generation from the light-emitting section 21, the distance between the first mirror 11 and the second mirror 12 can possibly fluctuate due to a thermal expansion and the light-receiving position of the light 30 in the light-receiving section 22 can possibly fluctuate. Accordingly, the sensor device 1 may include the mechanism for maintaining the overall temperature constant to improve the accuracy and a stability of the sensing. In such a case, it is preferable that the mechanism for maintaining the temperature constant be provided for each of the first mirror 11 and the second mirror 12.

### 1.4. CONCRETE EXAMPLES

### First Concrete Example

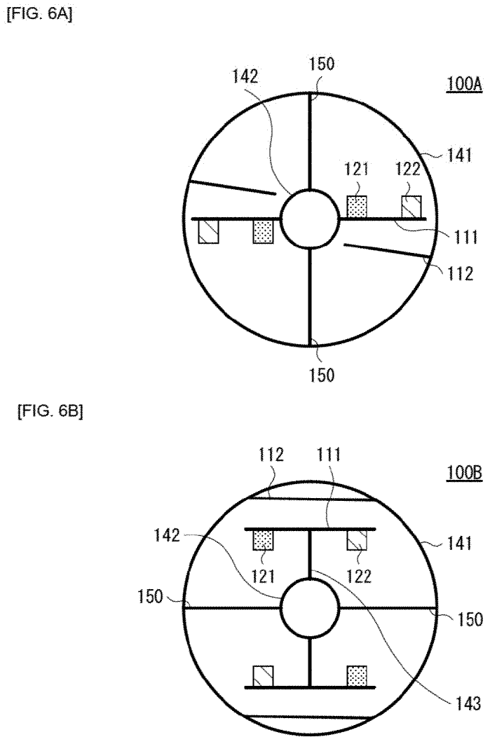

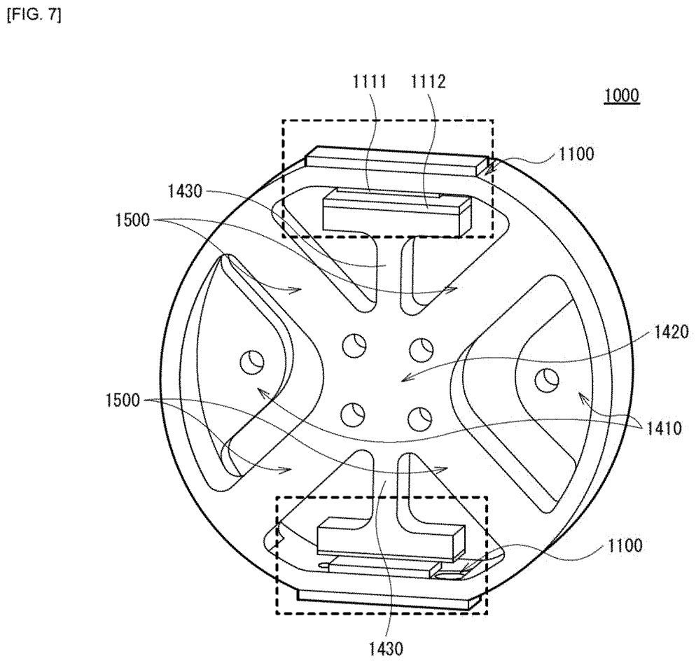

Next, a first concrete example of the sensor device 1 according to the present embodiment will be described with reference to FIGS. 6A to 9. FIGS. 6A and 6B are each a schematic diagram illustrating one mode of the first concrete example of the sensor device 1. FIGS. 7 to 9 are each a perspective diagram illustrating a detailed configuration of the first concrete example of the sensor device 1. The first concrete example of the sensor device 1 is a concrete example of a case where the sensor device 1 is used as a torque sensor.

Referring to FIG. 6A, as one mode of the first concrete example, a sensor device 100A may be configured by, for example, an outer wheel section 141, an inner wheel section 142, a strain-causing member section 150, a first mirror 111, a second mirror 112, a light-emitting section 121, and a light-receiving section 222.

The outer wheel section 141 and the inner wheel section 142 are each provided to have a circular shape of a concentric circle. The inner wheel section 142 has the circular shape whose diameter is smaller than that of the outer wheel section 141, and is coupled to the outer wheel section 141 via the strain-causing member section 150 that extends in a radial direction of the circular shape. The strain-causing member section 150 is provided as a member that is easily deformed as compared with the outer wheel section 141 and the inner wheel section 142, and deforms when a torque in which the center of the circular shape is a rotation axis is applied to the outer wheel section 141 or the inner wheel section 142.

The first mirror 111 is provided to extend, for example, from the inner wheel section 142 to the outer wheel section 141. The second mirror 112 is provided to extend from the outer wheel section 141 to the inner wheel section 142 in such a manner as to face the first mirror 111. The light-emitting section 121 is provided at an end part on the inner wheel section 142 side of the first mirror 111, and the light-receiving section 222 is provided at an end part on the outer wheel section 141 side of the first mirror 111. The light outputted from the light-emitting section 121 is subjected to the multiple reflection by the first mirror 111 and the second mirror 112 that face each other, following which the light is received by the light-receiving section 222. In a case where the light-emitting section 121 is provided on the inner wheel section 142 side and the light-receiving section 222 is provided on the outer wheel section 141 side, it is possible for the sensor device 100A to make greater the displacement amount of the light-receiving position of the light in the light-receiving section 222.

In the sensor device 100A, for example, in a case where the torque in which the center of the circular shape of the inner wheel section 142 is the rotation axis is applied to the inner wheel section 142, the strain-causing member section 150 is deformed to change an angle of the second mirror 112 with respect to the first mirror 111. This changes the light-receiving position of the light from the light-emitting section 121 in the light-receiving section 222, making it possible for the sensor device 100A to detect the torque applied to the inner wheel section 142. The sensor device 100A does not involve a change in the distance of the second mirror 112 with respect to the first mirror 111 by the deformation of the strain-causing member section 150, and thus makes it possible to prevent the distance between the first mirror 111 and the second mirror 112 from being shifted from a focal distance of a laser light source in a case where the light-emitting section 121 includes the laser light source.

In addition, referring to FIG. 6B, as another mode of the first concrete example, a sensor device 100B may be configured by, for example, the outer wheel section 141, the inner wheel section 142, a protrusion section 143, the strain-causing member section 150, the first mirror 111, the second mirror 112, the light-emitting section 121, and the light-receiving section 222.

The outer wheel section 141 and the inner wheel section 142 are each provided to have the circular shape of the concentric circle. The inner wheel section 142 has the circular shape whose diameter is smaller than that of the outer wheel section 141, and is coupled to the outer wheel section 141 via the strain-causing member section 150 that extends in the radial direction of the circular shape. The strain-causing member section 150 is provided as the member that is easily deformed as compared with the outer wheel section 141 and the inner wheel section 142, and deforms when the torque in which the center of the circular shape is the rotation axis is applied to the outer wheel section 141 or the inner wheel section 142.

The second mirror 112 is so provided, for example, as to connect, with a plane, two points of a circular arc of the outer wheel section 141. The first mirror 111 is so provided as to face the second mirror 112 at a tip of the protrusion section 143 that protrudes from the inner wheel section 142 to the outer wheel section 141 in a radial direction of the inner wheel section 142. The light-emitting section 121 is provided at one end part of the first mirror 111 and the light-receiving section 222 is provided at the other end part of the first mirror 111. The light outputted from the light-emitting section 121 is subjected to the multiple reflection by the first mirror 111 and the second mirror 112 that face each other, following which the light is received by the light-receiving section 222.

In the sensor device 100B, for example, in a case where the torque in which the center of the inner wheel section 142 is the rotation axis is applied to the inner wheel section 142, the strain-causing member section 150 is deformed to change an angle and a distance of the second mirror 112 with respect to the first mirror 111. This changes the light-receiving position of the light from the light-emitting section 121 in the light-receiving section 222, making it possible for the sensor device 100B to detect the torque applied to the inner wheel section 142. It is possible for the sensor device 100B to change the angle and the distance of the second mirror 112 with respect to the first mirror 111 by the deformation of the strain-causing member section 150, making it possible to further improve the sensitivity of the sensing.

Further, referring to FIG. 7, as a detailed configuration of the first concrete example, a sensor device 1000 may be configured by, for example, a base side attachment section 1410, a tip side attachment section 1420, a strain-causing member section 1500, a protrusion section 1430, and a sensing section 1100.

The base side attachment section 1410 is provided to have a circular shape, and is attached to one part of a target object of the sensing by a screw or the like. The tip side attachment section 1420 is provided at the center of the circular shape of the base side attachment section 1410, and is attached to the other part of the target object of the sensing by a screw or the like. The strain-causing member section 1500 is provided as a beam-shaped structure that couples the tip side attachment section 1420 and the base side attachment section 1410. The strain-causing member section 1500 is provided as a member that is easily deformed as compared with the tip side attachment section 1420 and the base side attachment section 1410. The deformation of the strain-causing member section 1500 changes an angle between the tip side attachment section 1420 and the base side attachment section 1410.

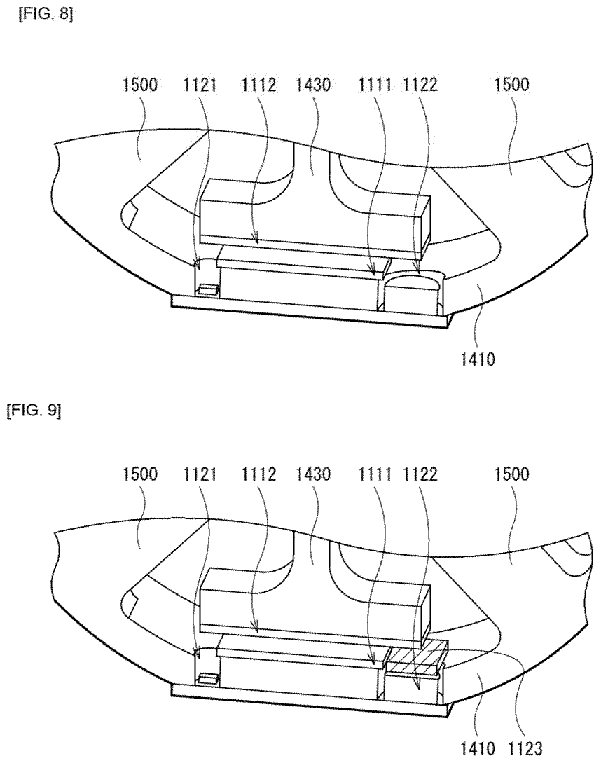

The sensing section 1100 includes: a first mirror 1111 provided on the base side attachment section 1410; a second mirror 1112 provided at a tip of the protrusion section 1430 that protrudes from the tip side attachment section 1420 to the base side attachment section 1410; and an unillustrated light-emitting section and an unillustrated light-receiving section that are provided inside the base side attachment section 1410. A configuration of the sensing section 1100 will be described with reference to FIG. 8. FIG. 8 is a perspective diagram illustrating the sensing section 1100 of FIG. 7 in a partial cross section.

Referring to FIG. 8, the first mirror 1111 is provided along an inner circumferential surface of the circular shape of the base side attachment section 1410. Further, a light-emitting section 1121 includes a light source such as LED, and is provided inside the base side attachment section 1410. A light-receiving section 1122 includes an imaging device such as a CMOS image sensor, and is provided inside the base side attachment section 1410 on an opposite side of the light-emitting section 1121 with the first mirror 1111 interposed therebetween. The second mirror 1112 is coupled to the tip side attachment section 1420 via a protrusion section 1130, and is so provided as to face the first mirror 1111, the light-emitting section 1121, and the light-receiving section 1222. The light outputted from the light-emitting section 1121 to the second mirror 1112 is reflected mutually between the second mirror 1112 and the first mirror 1111, following which the light is received by the light-receiving section 1222.

In the sensor device 1000, for example, in a case where a torque in which the center of the circular shape of the base side attachment section 1410 is a rotation axis is applied to the tip side attachment section 1420, the strain-causing member section 1500 having the beam-shaped structure that couples the base side attachment section 1410 and the tip side attachment section 1420 is deformed. Thus, an angle between the first mirror 1111 provided at the base side attachment section 1410 and the second mirror 1112 provided at the tip side attachment section 1420 changes, whereby a displacement of the light-receiving position of the light having been subjected to the multiple reflection therebetween is detected by the light-receiving section 1222. Hence, it is possible for the sensor device 1000 to detect the torque applied to the tip side attachment section 1420.

It is to be noted that, in a case where the number of reflections of the light between the first mirror 1111 and the second mirror 1112 is large, there is a possibility that it is not possible to separate respective light spots of the reflection light from each other because a distance between the respective light spots of reflection light becomes small. For example, in a case where the respective light spots of the reflection light are present on a substantially straight line as illustrated in FIG. 4A, the distance between the respective light spots of the reflection light tends to become small, and there is a possibility that it is not possible to separate the respective light spots of the reflection light from each other as described above accordingly. On the other hand, in a case where the respective light spots of the reflection light are present on a curved line as illustrated in FIG. 4B, the distance between the respective light spots of the reflection light tends to become large, and the respective light spots of the reflection light are highly likely to be separated from each other accordingly.

Accordingly, for example, so providing the first mirror 1111 and the second mirror 1112 as to be inclined with respect to each other in a perpendicular direction with respect to a direction in which the multiple reflection of the light proceeds makes it possible to cause the respective light spots of the reflection light to be present on the curved line as illustrated in FIG. 4B. With this configuration, it is possible for the sensor device 1000 to suppress the decrease in the detection sensitivity resulting from the mutual overlapping of the respective light spots of the reflection light.

In addition, it is possible for the sensor device 1000 to improve the sensitivity or the accuracy of the sensing by further providing another configuration on the light-receiving section 1222.

For example, referring to FIG. 9, in the sensor device 1000, a half mirror 1123 may be provided on the light-receiving section 1222. The half mirror 1123 is an optical element that, for example, reflects a portion of the incident light (e.g., about 50%), and allows the remaining part of the incident light to transmit therethrough. For example, in a case where the light-receiving section 1222 is large, a region in which the first mirror 1111 is provided is reduced and there is a possibility that the number of reflections between the first mirror 1111 and the second mirror 1112 is reduced. Providing the half mirror 1123 on the light-receiving section 1222 makes it possible to further reflect the light between the half mirror 1123 and the second mirror 1112 while causing the light to enter the light-receiving section 1222. With this configuration, it is possible for the sensor device 1000 to secure the number of reflections of the multiple reflection regardless of a size and a position of the light-receiving section 1222.

Further, in the sensor device 1000, a magnifying glass may be provided on the light-receiving section 1222. The magnifying glass makes it possible to improve a sensitivity to a light spot group of the light to be detected by the light-receiving section 1222 by enlarging the light spot group of the light reflected by the second mirror 1112. However, in a case where the light spot group of the light reflected by the second mirror 1112 is enlarged by the magnifying glass, sizes of the respective light spots are enlarged, increasing the possibility that the respective light spots are not separated from each other. In such a case, the light-receiving section 122 may detect only a portion of the second mirror 1112 to prevent the respective light spots from becoming inseparable from each other.

### Second Concrete Example

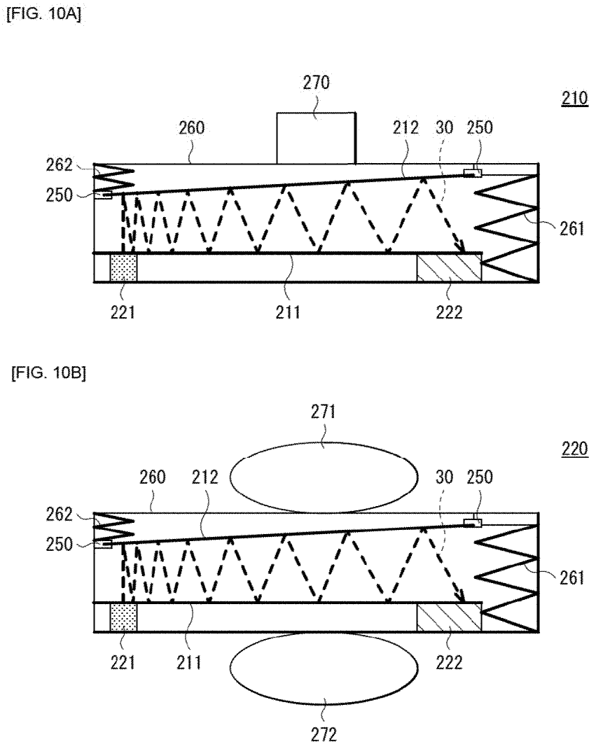

Next, a second concrete example of the sensor device 1 according to the present embodiment will be described with reference to FIGS. 10A and 10B. FIGS. 10A and 10B are each a schematic diagram illustrating one mode of the second concrete example of the sensor device 1. The second concrete example of the sensor device 1 is a concrete example in a case where the sensor device 1 is used as a load cell or a uniaxial force sensor.

Referring to FIG. 10A, as one mode of the second concrete example, a sensor device 210 may be configured by, for example, a housing 260, a first elastic section 261, a second elastic section 262, a strain-causing member section 250, a load section 270, a light-emitting section 221, a light-receiving section 222, a first mirror 211, and a second mirror 212. The sensor device 210 is used, for example, as the load cell that detects a load applied to the load section 270.

The housing 260 contains respective parts of the sensor device 210. The first mirror 211, the light-emitting section 221, and the light-receiving section 222 are fixed on a lower face side of the housing 260. On the other hand, the second mirror 212 is so provided on an upper face side of the housing 260 as to face the first mirror 211, and is coupled to the housing 260 via the strain-causing member section 250. The light outputted from the light-emitting section 221 is subjected to the multiple reflection by the first mirror 211 and the second mirror 212 that face each other, following which the light is received by the light-receiving section 222. In a case where a load is applied to the load section 270 provided on an upper face of the housing 260, the strain-causing member section 250 is deformed, thereby changing the angle of the first mirror 211 with respect to the second mirror 212. Thus, the light-receiving position of the light from the light-emitting section 221 in the light-receiving section 222 is changed, making it possible for the sensor device 210 to detect a magnitude of the load applied to the load section 270.

It is to be noted that the second mirror 212 and the housing 260 are further coupled by the first elastic section 261 and the second elastic section 262. The first elastic section 261 and the second elastic section 262 each may be, for example, a spring. With this configuration, when the load on the load section 270 is removed, it is possible for the second mirror 212 to return to its original state by an elastic force of the first elastic section 261 and the second elastic section 262.

Further, referring to FIG. 10B, as one mode of the second concrete example, a sensor device 220 may be configured by, for example, the housing 260, the first elastic section 261, the second elastic section 262, the strain-causing member section 250, force acting sections 271 and 272, the light-emitting section 221, the light-receiving section 222, the first mirror 211, and the second mirror 212. The sensor device 210 is used, for example, as the uniaxial force sensor.

A configuration of the sensor device 220 illustrated in FIG. 10B is substantially similar to the configuration of the sensor device 210 illustrated in FIG. 10A. While the sensor device 210 illustrated in FIG. 10A detects only a force in a compression direction from the load section 270 provided on the upper face of the housing 260, the sensor device 220 illustrated in FIG. 10B detects each of a force in a compression direction and a force in a tensile direction from the acting sections 271 and 272 provided respectively on an upper face and a lower face of the housing 260.

Specifically, the light outputted from the light-emitting section 221 is subjected to the multiple reflection by the first mirror 211 and the second mirror 212 that face each other, following which the light is received by the light-receiving section 222. In a case where the force is applied to the force acting sections 271 and 272 provided on the upper face and the lower face of the housing 260 in the compression direction (a direction of contracting a distance between the force acting sections 271 and 272) or in the tensile direction (a direction of expanding the distance between the force acting sections 271 and 272), the strain-causing member section 250 deforms, thereby changing the angle of the second mirror 212 with respect to the first mirror 211. Thus, the light-receiving position of the light from the light-emitting section 221 in the light-receiving section 222 is changed, making it possible for the sensor device 220 to detect a direction and a magnitude of the force applied to the force acting sections 271 and 272.

### Third Concrete Example

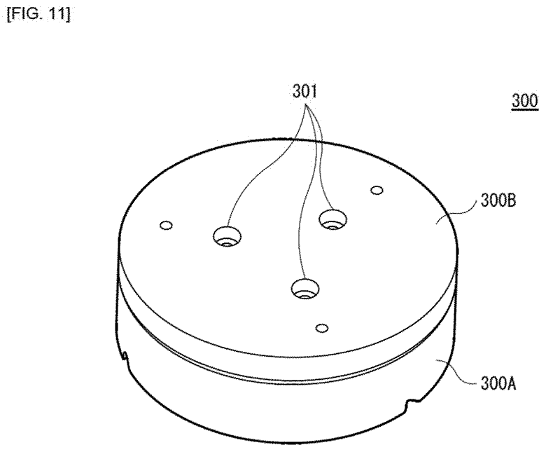

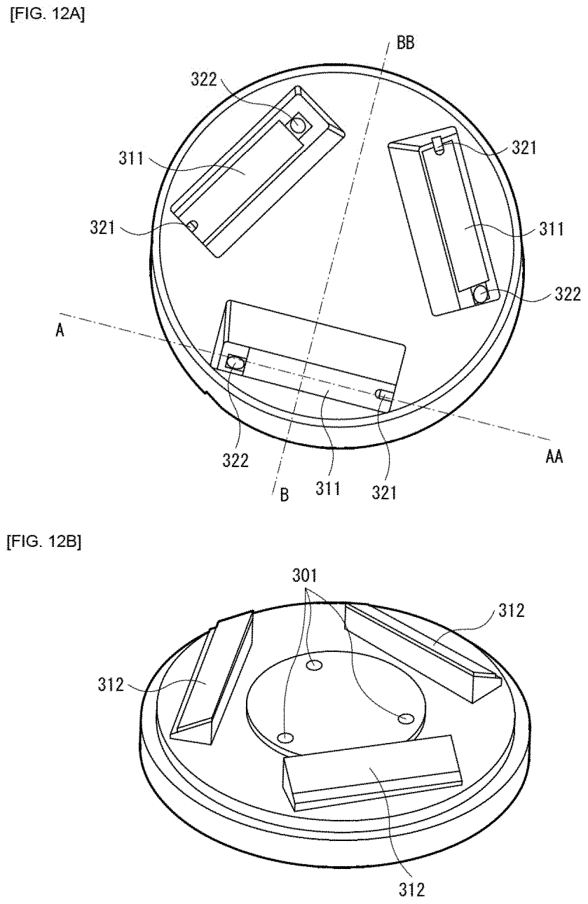

Next, a third concrete example of the sensor device 1 according to the present embodiment will be described with reference to FIGS. 11 to 13B. FIG. 11 is a perspective diagram illustrating a detailed configuration of the third concrete example of the sensor device 1. FIG. 12A is a perspective diagram illustrating a configuration on an attachment face side of a first member 300A, and FIG. 12B is a perspective diagram illustrating a configuration on an attachment face side of a second member 300B. The third concrete example of the sensor device 1 is a concrete example in a case where the sensor device 1 is used as a six-axis force sensor.

Referring to FIG. 11, a sensor device 300 may be configured by screwing the first member 300A and the second member 300B via a fastening section 301 and attaching them to each other. A low-rigidity, easy-to-deform strain-causing member section (not illustrated) is locally provided between the first member 300A and the second member 300B, and a deformation of the strain-causing member section changes the attachment between the first member 300A and the second member 300B. As will be described later, it is possible for the sensor device 300 to detect a force applied to the sensor device 300 by detecting a displacement of the light-receiving position of the light having been subjected to the multiple reflection between a first mirror provided on the first member 300A and a second mirror provided on the second member 300B.

Referring to FIG. 12A, the first member 300A is provided with first mirrors 311 extending in three directions that are different from each other, and a light-emitting section 321 and a light-receiving section 322 disposed on both sides in an extending direction of the first mirror 311. Further, referring to FIG. 12B, the second member 300B is provided with second mirrors 312 extending in three directions that are different from each other so as to face the first mirrors 311 provided on the first member 300A. The first member 300A and the second member 300B are attached to each other, whereby a sensor device that makes it possible to detect a deformation of two degrees of freedom is configured by the first mirror 311, the second mirror 312, the light-emitting section 321, and the light-receiving section 322. Accordingly, it is possible to configure the six-axis force sensor by providing three sets of first mirrors 311 and second mirrors 312 structuring the sensor device in the extending directions that are different from each other and in a facing direction. It should be noted that the three sets of first mirrors 311 and second mirrors 312 are disposed uniformly with respect to each other, allowing for uniformized sensing sensitivity and easier manufacturing of the sensor device 300.

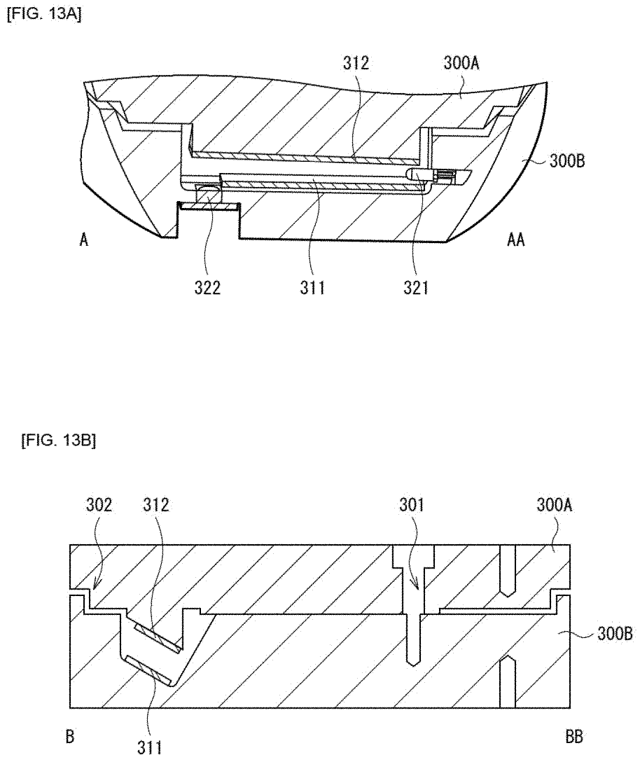

Here, a configuration of the sensor device configured by the first mirror 311, the second mirror 312, the light-emitting section 321, and the light-receiving section 322 will be described more specifically with reference to FIGS. 13A and 13B. FIGS. 13A and 13B are each a cross-sectional diagram illustrating more specifically a configuration of the sensor device configured by the first mirror 311, the second mirror 312, the light-emitting section 321, and the light-receiving section 322. FIG. 13A illustrates a cross section taken along a cut line A-AA illustrated in FIG. 12A, and FIG. 13B illustrates a cross section taken along a cut line B-BB illustrated in FIG. 12A.

Referring to FIGS. 13A and 13B, the first mirror 311 and the second mirror 312 are so provided as to face each other by attaching the first member 300A and the second member 300B to each other. The first mirror 311 and the second mirror 312 may be so provided that a distance between the first mirror 311 and the second mirror 312 gradually widens on the light-receiving section 322 side in order to allow the light from the light-emitting section 321 to reach the light-receiving section 322.

The light-emitting section 321 includes a light source such as LED, and is provided on one end part side of the first mirror 311. The light-receiving section 322 includes an imaging device such as a CMOS image sensor, and is provided on the other end part side of the first mirror 311. The light outputted from the light-emitting section 321 is subjected to the multiple reflection between the first mirror 311 and the second mirror 312, following which the light is received by the light-receiving section 322.

Here, a space in which the first mirror 311, the second mirror 312, the light-emitting section 321, and the light-receiving section 322 are provided may be shielded from light by a light entrance prevention structure 302 such that the light does not enter from the outside. With this configuration, it is possible to reduce a possibility that the sensor device 300 malfunctions due to the light from the outside. The light entrance prevention structure 302 may be, for example, a structure that shields the light from the outside by a structure such as a step.

Further, the space in which the first mirror 311, the second mirror 312, the light-emitting section 321, and the light-receiving section 322 are provided may include a structure member having a low light reflectance in order to suppress an influence of ambient light. For example, the inner side of the space in which the first mirror 311, the second mirror 312, the light-emitting section 321, and the light-receiving section 322 are provided may be treated with a black plating, a black treatment, a blackening treatment, or a black coating treatment. Further, the first mirror 311 and the second mirror 312 may be treated with the above-described black plating, black treatment, blackening treatment, black coating treatment, or the like for any portion not related to the reflection of the light outputted from the light-emitting section 321.

### 2. SECOND EMBODIMENT

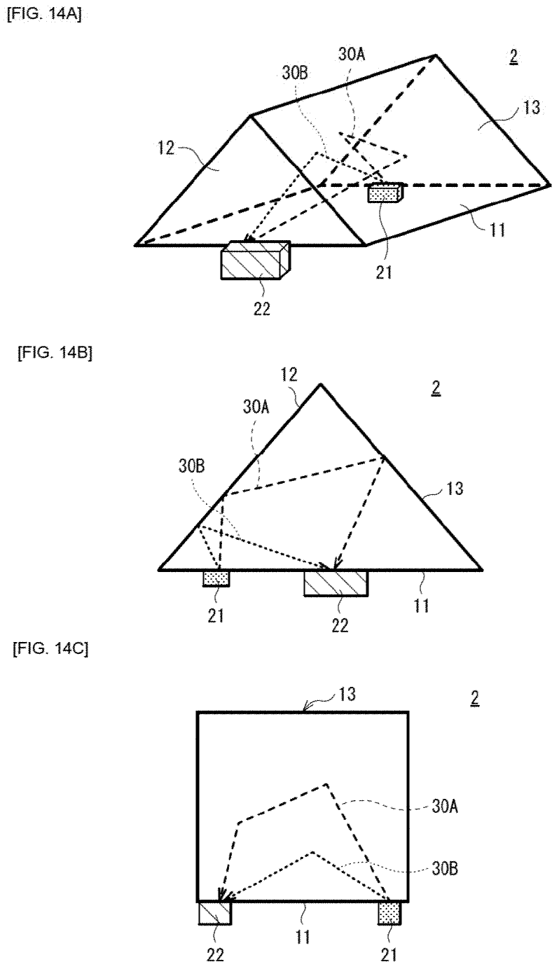

The following describes a basic configuration of a sensor device according to a second embodiment of the present disclosure with reference to FIGS. 14A to 18D. FIG. 14A is a perspective diagram schematically illustrating a basic configuration of a sensor device 2 according to the second embodiment of the present disclosure. FIG. 14B is a front diagram in which the sensor device 2 illustrated in FIG. 14A is viewed in a plan view in a direction from the light-receiving section 22 to the light-emitting section 21. FIG. 14C is a side diagram in which the sensor device 2 illustrated in FIG. 14A is viewed in a plan view from a third mirror 13.

Referring to FIGS. 14A to 14C, the sensor device 2 according to the present embodiment includes the first mirror 11, the second mirror 12, and the third mirror 13 that face each other, and the light-emitting section 21 and the light-receiving section 22. The first mirror 11, the second mirror 12, and the third mirror 13 face each other to be provided at positions corresponding to respective side surfaces of a triangular prism.

In the sensor device 2, light 30A and light 30B outputted from the light-emitting section 21 are reflected by the first mirror 11, the second mirror 12, and the third mirror 13 via light paths that are different from each other, respectively, following which the pieces of light are received by the light-receiving section 22. It is possible for the sensor device 2 according to the present embodiment to detect an external force applied to the sensor device 2 by detecting a displacement of a light-receiving position of the light in the light-receiving section 22.

In the sensor device 2 according to second embodiment, the light is outputted from the light-emitting section 21 inside a structure in which three or more reflection mirrors are combined, and the light outputted from the light-emitting section 21 passes through various light paths to be received by the light-receiving section 22. In such a case, the light outputted from the light-emitting section 21 is observed by the light-receiving section 22 as a spot group in which the number of light spots is amplified with respect to the number of light sources. Each light spot included in the spot group is displaced while including information on reflection surfaces in respective light paths. Accordingly, it is possible to regard the spot group of the reflection light observed by the light-receiving section 22 as three-dimensional information as a whole (information on six degrees of freedom if including a position and an attitude) even if the spot group is caused by the light outputted from one light source. With this configuration, by combining the three or more reflection mirrors, it is possible for the sensor device 2 to function as a six-axis force sensor even in a case where the light-emitting section 21 including one light source is used.

The sensor device 2 is simple in structure as compared with, for example, the sensor device 300 that functions as the six-axis force sensor described with reference to FIGS. 11 to 13B, making it possible to increase ease of manufacturing and a reliability of a device.

In addition, because an information amount of an observation result of the spot group of the light reflected by the first mirror 11, the second mirror 12, and the third mirror 13 increases as the number of light spots included in the spot group increases, it is possible for the sensor device 2 to further improve a sensitivity and an accuracy of a sensing result. Further, because the sensor device 2 is simple in structure as compared with the sensor device 300 described with reference to FIGS. 11 to 13B, it is possible to reduce a manufacturing error and the like and to simplify wiring lines and the like as well. Furthermore, in the sensor device 2, only one light-receiving section 22 is provided as compared with the sensor device 300 described with reference to FIGS. 11 to 13B, eliminating a necessity of performing a synchronization between the respective light-receiving sections 22 as compared with a case where the plurality of light-receiving sections 22 is provided. From this point of view, it is possible for the sensor device 2 to further improve the sensitivity and the accuracy of the sensing result.

It is possible for the sensor device 2 to detect a direction and a magnitude of a force applied to the second mirror 12, the third mirror 13, or a strain-causing member (not illustrated) coupled to these configurations through, for example, machine-learning of a displacement of the spot group of the light spots of the reflection light with respect to a displacement occurred at the second mirror 12 or the third mirror 13.

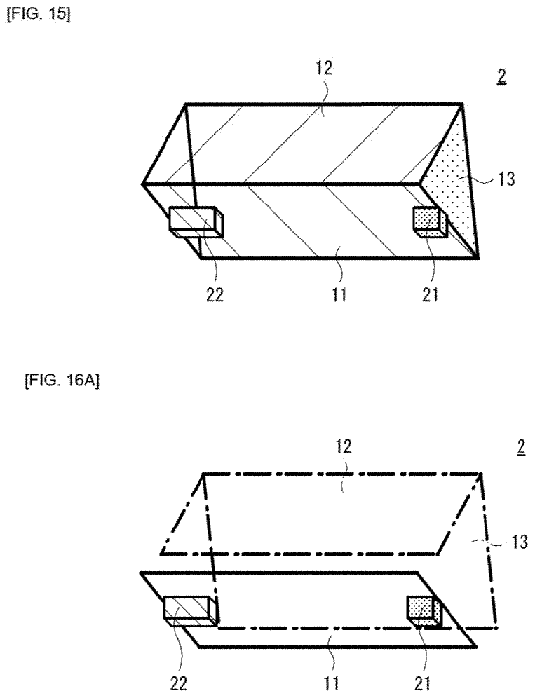

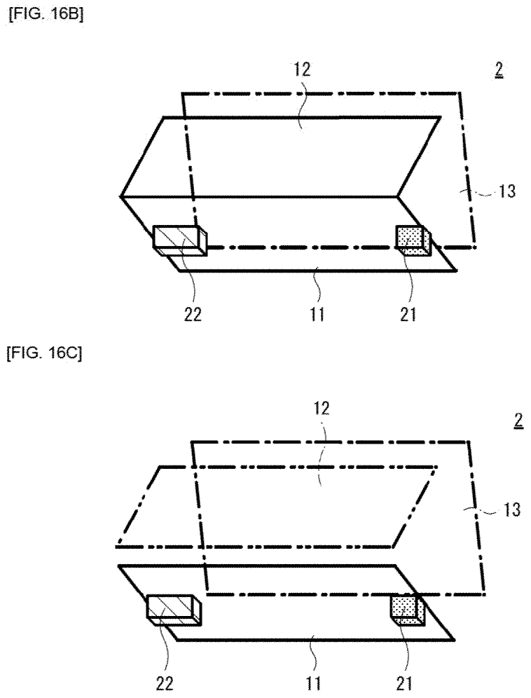

Referring now to FIGS. 15 to 16C, variations of a region in which a displacement by a strain-causing member occurs in the sensor device 2 will be described. FIG. 15 is a schematic diagram illustrating a basic structure of the sensor device 2 that uses three reflection mirrors. FIGS. 16A to 16C are each a schematic diagram illustrating a variation of a region in which a displacement occurs in the sensor device 2 illustrated in FIG. 15.

For example, referring to FIG. 15, a case is exemplified in which the first mirror 11 is provided with the light-emitting section 21 and the light-receiving section 22, and the second mirror 12 and the third mirror 13 are so provided as to constitute, together with the first mirror 11, side faces of the triangular prism.

In such a case, referring to FIG. 16A, the sensor device 2 may be provided such that the first mirror 11, the second mirror 12, and the third mirror 13 are provided in a divided fashion and such that a tilt of the second mirror 12 and the third mirror 13 is displaced by the coupled strain-causing member (not illustrated).

In addition, referring to FIG. 16B, the sensor device 2 may be provided such that the first mirror 11, the second mirror 12, and the third mirror 13 are provided in a divided fashion and such that a tilt of the third mirror 13 is displaced by the coupled strain-causing member (not illustrated).

Further, referring to FIG. 16C, the sensor device 2 may be provided such that the first mirror 11, the second mirror 12, and the third mirror 13 are each provided in a divided fashion and such that respective tilts of the second mirror 12 and the third mirror 13 are displaced independently of each other by the coupled strain-causing member (not illustrated).

Similarly, it is also possible to consider variations of a region in which a displacement occurs for a sensor device 3 that uses four reflection mirrors.

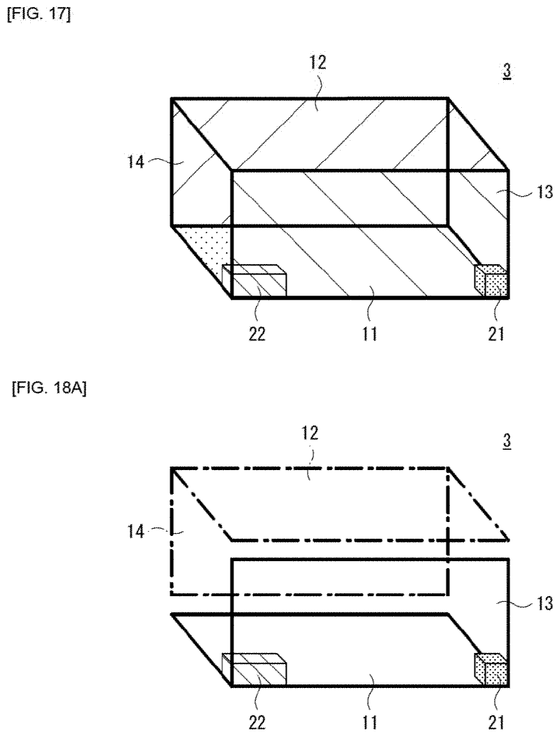

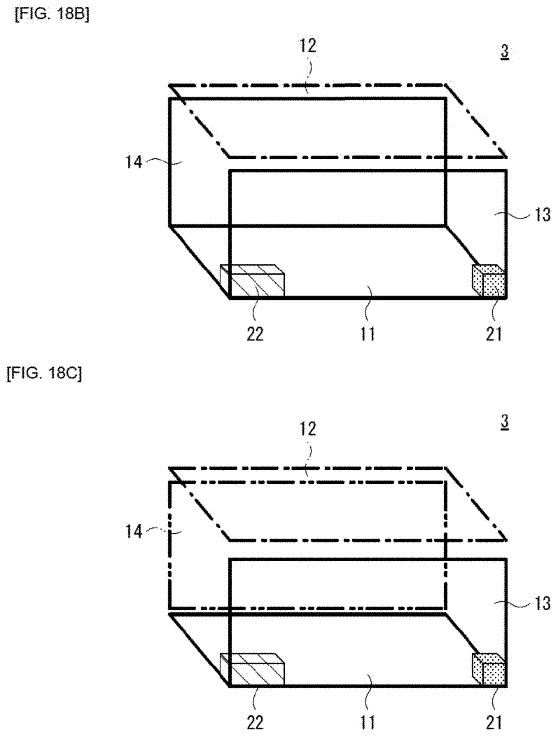

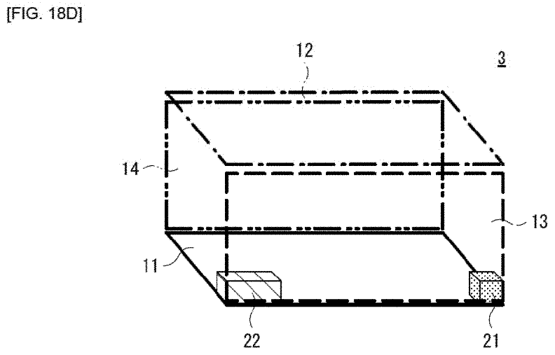

Referring to FIGS. 17 to 18D, variations of a region in which a displacement by a strain-causing member occurs in the sensor device 3 that uses four reflection mirrors will be described. FIG. 17 is a schematic diagram illustrating a basic structure of the sensor device 3 that uses four reflection mirrors. FIGS. 18A to 18D are each a schematic diagram illustrating a variation of a region in which a displacement occurs in the sensor device 3 illustrated in FIG. 17.

For example, referring to FIG. 17, a case is exemplified in which the first mirror 11 is provided with the light-emitting section 21 and the light-receiving section 22, and the second mirror 12, the third mirror 13, and a fourth mirror 14 are so provided as to constitute, together with the first mirror 11, side faces of a quadrangular prism.

In such a case, referring to FIG. 18A, the sensor device 3 may be provided such that the first and the third mirrors 11 and 13 and the second and the fourth mirrors 12 and 14 are provided in a divided fashion and such that a tilt of the second mirror 12 and the fourth mirror 14 is displaced by the coupled strain-causing member (not illustrated).

In addition, referring to FIG. 18B, the sensor device 3 may be provided such that the first, the third, and the fourth mirrors 11, 13, and 14 and the second mirror 12 are provided in a divided fashion and such that a tilt of the second mirror 12 is displaced by the coupled strain-causing member (not illustrated).

In addition, referring to FIG. 18C, the sensor device 3 may be provided such that the first and the third mirrors 11 and 13, the second mirror 12, and the fourth mirror 14 are each provided in a divided fashion and such that respective tilts of the second mirror 12 and the fourth mirror 14 are displaced independently of each other by the coupled strain-causing member (not illustrated).

Further, referring to FIG. 18D, the sensor device 3 may be provided such that the first and the second mirrors 11 and 12, the third mirror 13, and the fourth mirror 14 are each provided in a divided fashion and such that respective tilts of the second mirror 12, the third mirror 13, and the fourth mirror 14 are displaced independently of each other by the coupled strain-causing member (not illustrated).

It should be noted that, in the sensor device 2 according to the second embodiment, the number of reflection mirrors is not limited to the above example. In the sensor device 2, the number of reflection mirrors may be three or four or more such as five or six, as long as the reflection mirrors are so disposed as to have a space therein and as to constitute side faces of a polygonal prism. However, from a viewpoint of a complexity of a structure and ease of manufacturing, the number of reflection mirrors included in the sensor device may be six or less.

### 3. CONCLUSION

As described above, the sensor device according to one embodiment of the present disclosure has a simplified structure and allows for formation with high rigidity accordingly. In addition, it is possible for the sensor device according to the present embodiment to detect a strain or a force with high sensitivity and high accuracy.

It is possible to use the sensor device according to one embodiment of the present disclosure as a load cell, a torque sensor, or a multi-axis force sensor, for example. It is also possible to apply the sensor device according to one embodiment of the present disclosure to a load cell, a torque sensor, or a multi-axis force sensor to be mounted on a wrist, an ankle, a finger, or the like of an arm of a robot for industrial use or the like. Further, it is also possible to apply the sensor device according to one embodiment of the present disclosure to a load cell, a torque sensor, or a multi-axis force sensor in various applications such as fluid measurement, a force sensor for mounting lower limb orthotics, behavior monitoring of a precision press, monitoring of an electrode pressurizing force of spot welding, monitoring of cable terminal crimping force, or measuring a bolt-tightening axial force.

A technique according to the present disclosure has been described above with reference to the first and the second embodiments and the modification examples. However, the technique according to the present disclosure is not limited to the above-described embodiments, and various modifications can be made.

In addition, it is possible to combine the modification examples described in the above first embodiment with each other as well.

Further, not all of the configurations and operations described in the respective embodiments are essential to the configuration and the operation of the present disclosure. For example, among the elements in the respective embodiments, elements not described in an independent claim based on the most generic concept of the present disclosure are to be understood as optional components.

The terms used throughout this specification and the appended claims should be construed as “non-limiting” terms. For example, the terms “including” or “included” should be construed as “not being limited to an embodiment in which it is described as including”. The term “has” should be construed as “not being limited to an embodiment in which it is described as having”.

The terms used in this specification are used merely for convenience of description and include terms that are not used for the purpose of limiting a configuration and an operation. For example, terms such as “right,” “left,” “up,” and “down” merely indicate a direction in the drawing being referenced. In addition, the terms “inner” and “outer” merely indicate directions toward the center of an element of interest and away from the center of the element of interest, respectively. This applies similarly to terms similar to these terms and terms having the similar meanings.

It should be noted that the technique according to the present disclosure may have the following configurations. According to the technique of the present disclosure having the following configurations, it is possible for the sensor device to make larger a displacement of a light-receiving position of reflection light by a displacement of the second mirror by causing the light outputted from the light-emitting section to be subjected to the multiple reflection between the first mirror and the second mirror. Thus, the sensor device allows for formation with high rigidity and makes it possible to detect an external force or a deformation of an object by the external force with higher sensitivity and higher accuracy. An effect to be exerted by the technique according to the present disclosure is not necessarily limited to the effect described herein, and may be any of the effects described in the present disclosure.

(1)

A sensor device including:

a light-emitting section that outputs light to a first mirror or a second mirror, the second mirror facing the first mirror and being configured to change an orientation with respect to the first mirror; and

a light-receiving section that receives reflection light, reflected from the first mirror and the second mirror, of the light outputted from the light-emitting section.

(2)

The sensor device according to (1), in which the light-receiving section receives the light outputted from the light-emitting section and having been subjected to a multiple reflection by the first mirror and the second mirror.

(3)

The sensor device according to (1) or (2), in which the light-receiving section detects an entrance position of the reflection light to the light-receiving section.

(4)

The sensor device according to (3), further including a force detecting section that determines a magnitude of an external force that has changed the orientation of the second mirror, on the basis of a displacement of the entrance position of the reflection light detected by the light-receiving section.

(5)

The sensor device according to any one of (1) to (4), in which the light-emitting section and the light-receiving section are provided on a same side with respect to the first mirror and the second mirror.

(6)

The sensor device according to (5), in which the light-emitting section and the light-receiving section are provided on a side on which the first mirror is present with respect to the second mirror.

(7)

The sensor device according to any one of (1) to (6), in which the first mirror and the second mirror have a longitudinal shape that extends in one direction.

(8)

The sensor device according to (7), in which

the light-emitting section is provided at one first end in a longitudinal direction of the longitudinal shape, and

the light-receiving section is provided at a second end, in the longitudinal direction, that faces the first end.

(9)

The sensor device according to any one of (1) to (8), further including:

the first mirror; and

the second mirror.

(10)

The sensor device according to (9), in which

the first mirror and the second mirror are coupled via a strain-causing member section; and

the second mirror changes the orientation with respect to the first mirror by a deformation of the strain-causing member section.

(11)

The sensor device according to (10), in which the second mirror changes the orientation with respect to the first mirror by pivoting, by the deformation of the strain-causing member section, in a circumferential direction of a circle in which a direction perpendicular to an extending direction of the first mirror is a radial direction.

(12)

The sensor device according to any one of (1) to (11), in which the light-emitting section includes a plurality of light sources.

(13)

The sensor device according to (12), in which the light-emitting section includes the plurality of light sources that emits pieces of light of wavelength bands that are different from each other.

(14)

The sensor device according to any one of (1) to (13), in which the light-receiving section includes a plurality of sensors configured to detect light.

(15)

The sensor device according to (14), in which the light-receiving section includes at least any one of an RGB camera, an infrared camera, or an event camera.

(16)

The sensor device according to any one of (1) to (15), in which at least any one of the first mirror or the second mirror includes a bent or curved mirror, or a plurality of mirrors spaced apart from each other.

(17)

The sensor device according to any one of (9) to (11), further including a third mirror that faces each of the first mirror and the second mirror and constitutes, together with the first mirror and the second mirror, side faces of a triangular prism.

(18)

The sensor device according to (17), in which the light-receiving section detects a light spot group of the light outputted from the light-emitting section and having been subjected to a multiple reflection by the first mirror, the second mirror, and the third mirror.

(19)

The sensor device according to (17) or (18), in which the third mirror is configured to change an orientation with respect to the first mirror either integrally with the second mirror or independently of the second mirror.

(20)

The sensor device according to any one of (9) to (11), further including a third mirror and a fourth mirror that face each of the first mirror and the second mirror and constitute, together with the first mirror and the second mirror, side faces of a quadrangular prism.

The present application claims the benefit of Japanese Priority Patent Application JP2019-198483 filed with the Japan Patent Office on Oct. 31, 2019, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. A sensor device comprising:
a light-emitting section that outputs light to a first mirror or a second mirror, the second mirror facing the first mirror and being configured to change an orientation with respect to the first mirror; and
a light-receiving section that receives reflection light, reflected from the first mirror and the second mirror, of the light outputted from the light-emitting section.

2. The sensor device according to claim 1, wherein the light-receiving section receives the light outputted from the light-emitting section and having been subjected to a multiple reflection by the first mirror and the second mirror.

3. The sensor device according to claim 1, wherein the light-receiving section detects an entrance position of the reflection light to the light-receiving section.

4. The sensor device according to claim 3, further comprising a force detecting section that determines a magnitude of an external force that has changed the orientation of the second mirror, on a basis of a displacement of the entrance position of the reflection light detected by the light-receiving section.

5. The sensor device according to claim 1, wherein the light-emitting section and the light-receiving section are provided on a same side with respect to the first mirror and the second mirror.

6. The sensor device according to claim 5, wherein the light-emitting section and the light-receiving section are provided on a side on which the first mirror is present with respect to the second mirror.

7. The sensor device according to claim 1, wherein the first mirror and the second mirror have a longitudinal shape that extends in one direction.

8. The sensor device according to claim 7, wherein
the light-emitting section is provided at one first end in a longitudinal direction of the longitudinal shape, and
the light-receiving section is provided at a second end, in the longitudinal direction, that faces the first end.

9. The sensor device according to claim 1, further comprising:
the first mirror; and
the second mirror.

10. The sensor device according to claim 9, wherein
the first mirror and the second mirror are coupled via a strain-causing member section; and
the second mirror changes the orientation with respect to the first mirror by a deformation of the strain-causing member section.

11. The sensor device according to claim 10, wherein the second mirror changes the orientation with respect to the first mirror by pivoting, by the deformation of the strain-causing member section, in a circumferential direction of a circle in which a direction perpendicular to an extending direction of the first mirror is a radial direction.

12. The sensor device according to claim 1, wherein the light-emitting section includes a plurality of light sources.

13. The sensor device according to claim 12, wherein the light-emitting section includes the plurality of light sources that emits pieces of light of wavelength bands that are different from each other.

14. The sensor device according to claim 1, wherein the light-receiving section includes a plurality of sensors configured to detect light.

15. The sensor device according to claim 14, wherein the light-receiving section comprises at least any one of an RGB camera, an infrared camera, or an event camera.

16. The sensor device according to claim 1, wherein at least any one of the first mirror or the second mirror comprises a bent or curved mirror, or a plurality of mirrors spaced apart from each other.

17. The sensor device according to claim 9, further comprising a third mirror that faces each of the first mirror and the second mirror and constitutes, together with the first mirror and the second mirror, side faces of a triangular prism.

18. The sensor device according to claim 17, wherein the light-receiving section detects a light spot group of the light outputted from the light-emitting section and having been subjected to a multiple reflection by the first mirror, the second mirror, and the third mirror.

19. The sensor device according to claim 17, wherein the third mirror is configured to change an orientation with respect to the first mirror either integrally with the second mirror or independently of the second mirror.

20. The sensor device according to claim 9, further comprising a third mirror and a fourth mirror that face each of the first mirror and the second mirror and constitute, together with the first mirror and the second mirror, side faces of a quadrangular prism.
